(19) United States
(12) Patent Application Publication
(10) Pub. No.: US 2026/0348768 A1
(43) Pub. Date: Nov. 5, 2026

(54) SENSOR ASSEMBLY FOR A CONNECTOR

(71) Applicant: TE Connectivity Solutions GmbH, Schaffhausen (CH)

(72) Inventors: David Bruce Sarraf, Middletown, PA (US); Abhishek Krishna, Bangalore (IN)

(73) Assignee: TE Connectivity Solutions GmbH, Schaffhausen (CH)

(21) Appl. No.: 19/198,488

(22) Filed: May 5, 2025

(51) Int. Cl. G01K 1/16; H01R 13/639; H01R 13/66

(52) U.S. Cl. CPC G01K 1/16; H01R 13/639; H01R 13/6683

(57) ABSTRACT

A sensing system includes a pin extending along an axial direction and a sensor assembly positioned adjacent to the pin. The sensor assembly includes a carrier, a temperature sensor disposed on the carrier, and a boot positioned between the temperature sensor and an outer surface of the pin. A flow path of a heat emitted by the pin extends along the axial direction from the outer surface of the pin to the temperature sensor.

### FIELD OF THE INVENTION

The present invention relates to a sensor assembly and, more particularly, to a sensor assembly used to monitor a temperature of a pin.

### BACKGROUND OF THE INVENTION

Electrical connectors have pins or terminals that mate with the pins of a mating connector. An electrical current is passed along the connected pins and, in some applications, such as when the connector is an inlet for charging an electric vehicle, a heat generated by the electrical current in the pins can be sufficiently high to damage the pins or create other safety concerns. Consequently, some electrical connectors have temperature sensors that monitor the temperature of the pins during use; the signals provided by the temperature sensors can be used, for example, to stop the flow of electrical current if the pin temperature is too high.

To accurately monitor the temperature of the pin, the signal provided by the temperature sensor should represent the current temperature of the pin as closely as possible. In current connectors, however, the temperature sensor is arranged such that a heat emitted by the pin must first flow radially from the pin through a silicone boot, though a metallized layer on a printed circuit board and into the printed circuit board, then change direction before reaching the temperature sensor on the printed circuit board. The forward flow path from the pin to the temperature sensor has a high thermal resistance. Further, the temperature sensor of current connectors is positioned adjacent to ambient air; a leak path of heat from the sensor has a low thermal resistance due to the exposure to and convection of the ambient air.

In current connectors, the high thermal resistance between the pin and the temperature sensor, and the low thermal resistance between the temperature sensor and the ambient air, negatively impact the accuracy of the temperature sensed by the temperature sensor. The temperature sensor, for example, may only experience around 80% of the heat rise of the pin and the temperature signal provided by the temperature sensor may lag up to 5 minutes behind the actual pin temperature. The temperature sensor thus does not accurately reflect the current temperature of the pin.

### SUMMARY OF THE INVENTION

A sensing system includes a pin extending along an axial direction and a sensor assembly positioned adjacent to the pin. The sensor assembly includes a carrier, a temperature sensor disposed on the carrier, and a boot positioned between the temperature sensor and an outer surface of the pin. A flow path of a heat emitted by the pin extends along the axial direction from the outer surface of the pin to the temperature sensor.

### BRIEF DESCRIPTION OF DRAWINGS

The invention will now be described by way of example with reference to the accompanying Figures, of which:

FIG. 1 is a perspective view of a connector according to an embodiment;

FIG. 2 is a sectional top view of the connector, taken along line 2-2 of FIG. 1;

FIG. 3 is a perspective view of a sensing system of the connector;

FIG. 4 is another perspective view of the sensing system;

FIG. 5 is a detail view of a portion D of FIG. 2;

FIG. 6 is a detail sectional perspective view of a sensing system according to another embodiment;

FIG. 7 is a perspective view of a sensing system according to a further embodiment; and

FIG. 8 is a detail sectional view of the sensing system of FIG. 7, taken along line 8-8 of FIG. 7.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth to provide a thorough understanding of the disclosed embodiments. However, it is apparent that one or more embodiments may also be implemented without these specific details.

Throughout the drawings, only one of a plurality of identical elements may be labeled in a figure for clarity of the drawings, but the detailed description of the element herein applies equally to each of the identically appearing elements in the figure. Throughout the specification, directional descriptors are used such as “axial direction” and “radial direction”. These descriptors are merely for clarity of the description and for differentiation of the various directions. These directional descriptors do not imply or require any particular orientation of the disclosed elements.

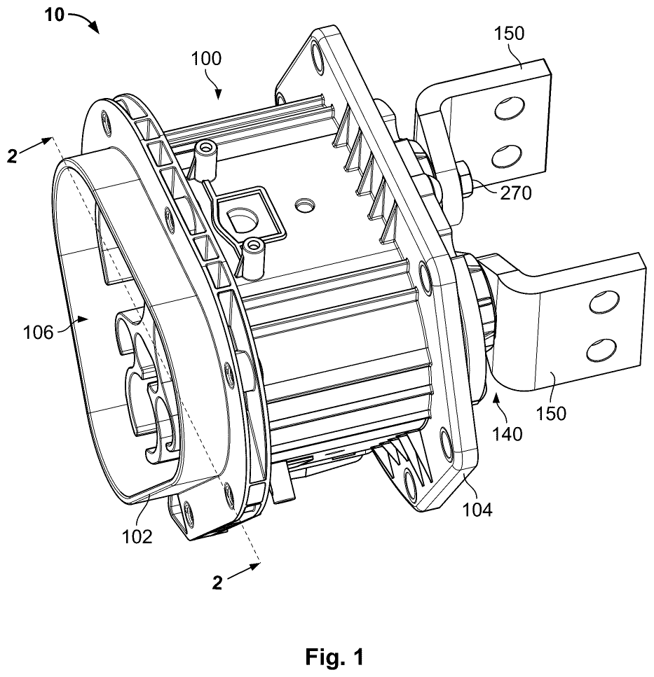

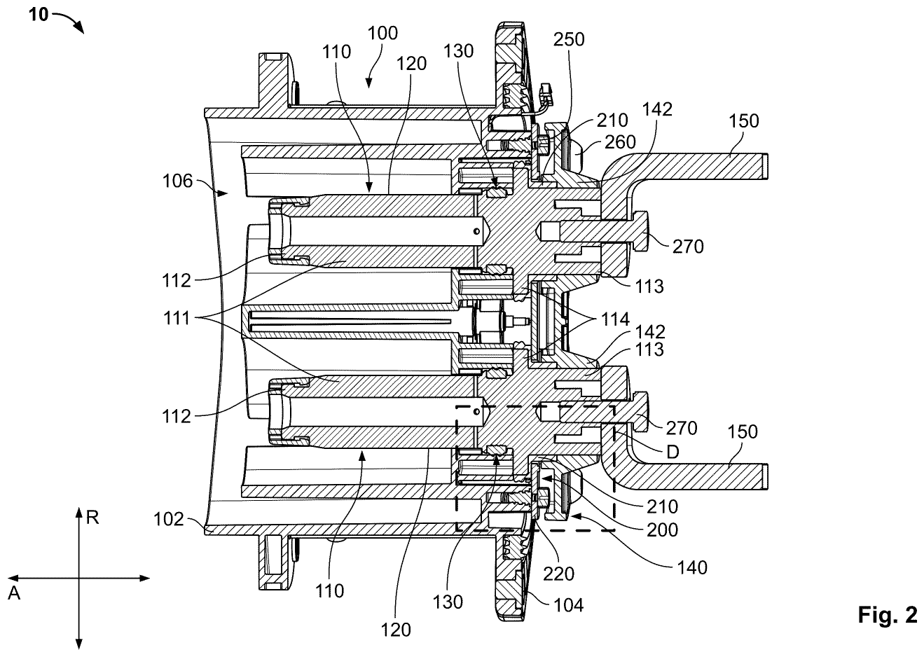

A connector 10 according to an embodiment is shown in FIGS. 1 and 2. The connector 10 includes a housing 100, at least one pin 110 disposed in the housing 100, and a sensor assembly 200 positioned adjacent to the pin 110. Through the present specification, the assembly of the pin 110 and the sensor assembly 200 will be referred to as a sensing system 20.

In the shown embodiment, the connector 10 is a charging inlet for an electric vehicle and has two pins 110 that are used to conduct an electrical current used to charge the electric vehicle. In other embodiments, the connector 10 may be used for any other electrical connection applications in which it is desirable to accurately determine the temperature of the pin 110. In alternative embodiments, the connector 10 may have one pin 110 or more than two pins 110.

The housing 100, as shown in FIGS. 1 and 2, has a mating side 102 and a connection side 104 opposite the mating side 102 along an axial direction A. Throughout the specification, the axial direction A is in reference to an axial extension of the at least one pin 110, as shown in FIG. 2. The housing 100 has a mating opening 106 at the mating side 102 that receives a mating connector matable with the connector 10. The housing 100 is formed of an insulative material.

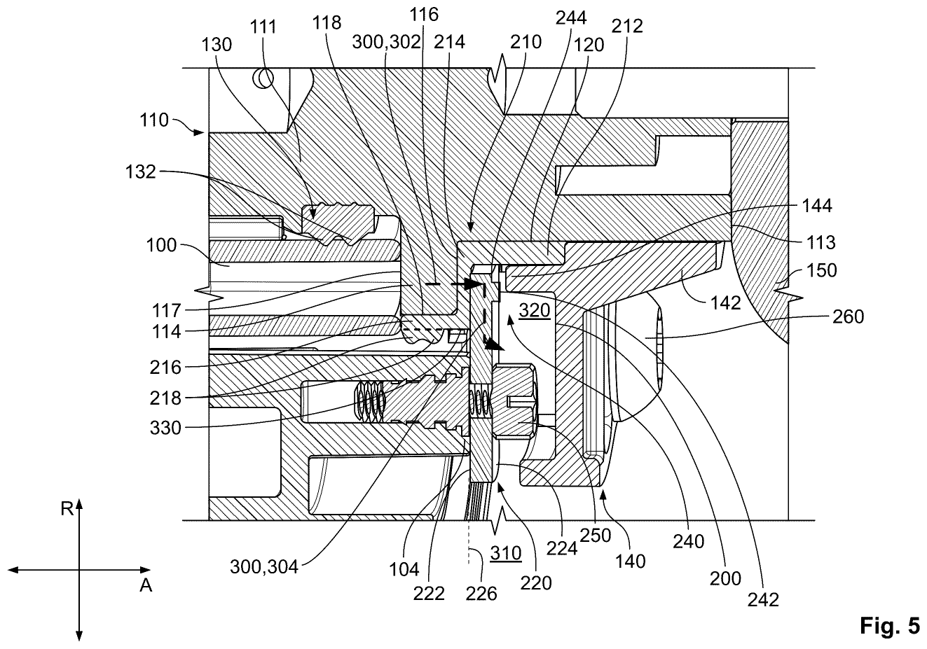

As shown in FIG. 2, the pins 110 have a body 111 extending between a mating end 112 and a connection end 113 along the axial direction A. Between the mating end 112 and the connection end 113, the pins 110 have a flange 114 extending from an outer surface 120 of the body 111 in a radial direction R of the pin 110 perpendicular to the axial direction A. As shown in detail in FIG. 5, the flange 114 has a sensor side 116 and a housing side 117 opposite the sensor side 116 along the axial direction A; the sensor side 116 and the housing side 117 each extend in the radial direction R. The flange 114 has an outer side 118 extending between the sensor side 116 and the housing side 117 along the axial direction A. The sensor side 116, the housing side 117, and the outer side 118 of the flange 114 define part of the outer surface 120 of the pin 110.

In the shown embodiment, body 111 and the flange 114 have a circular cross-section at the outer surface 120 and the flange 114 extends circumferentially around the pin 110. In another embodiment, the body 111 and the flange 114 may have other cross-sectional shapes, such as a polygonal cross-sectional shape.

In the shown embodiment, the pins 110 are identical to one another and are each monolithically formed in a single piece from a conductive material, such as copper, a copper alloy, or aluminum. In other embodiments, the pins 110 may be formed from a plurality of pieces of the conductive material assembled together into the arrangement described above.

The sensor assembly 200, as shown in FIGS. 2-5, has a boot 210, a carrier 220 positioned adjacent to the boot 210, and a temperature sensor 240 disposed on the carrier 220.

The boot 210, as shown in FIGS. 2-5, has a shape corresponding to a shape of the body 111 and the flange 114 of the pin 110. In the shown embodiment, the boot 210 has a first section 212 extending along the axial direction A that is sized to fit around the body 111 of the pin 110, a second section 214 extending from the first section 212 in the radial direction R, and a third section 216 extending from an end of the second section 214 opposite the first section 212. The third section 216 extends along the axial direction A and is sized to fit around the flange 114 of the pin 110. As shown in FIG. 5, the boot 210 has a plurality of boot ribs 218 extending outward from the third section 216.

The boot 210 is formed of an elastically deformable material that is thermally conductive and electrically insulative, such as silicone or another type of rubber. The material of the boot 210, in an embodiment, is sufficiently electrically insulative to withstand a 600-1200 V potential difference and/or remains intact at temperatures up to 120°C. In the shown embodiment, the boot 210 is monolithically formed in a single piece from the thermally conductive and electrically insulative material. In another embodiment, the boot 210 can be formed of a plurality of pieces of the thermally conductive and electrically insulative material assembled together into the arrangement described above.

The carrier 220, shown in FIGS. 2-5, is a printed circuit board (PCB) having a first side 222 and a second side 224 opposite the first side 222 in the axial direction A. The carrier 220 is approximately planar and extends along a carrier plane 226, shown in FIG. 5, that is parallel to the radial direction R and perpendicular to the axial direction A. The carrier 220 may be formed of any type of insulative material used in PCBs, such as fiberglass, and has a plurality of traces used to connect electrical components mounted on the carrier 220 or otherwise connected to the carrier 220.

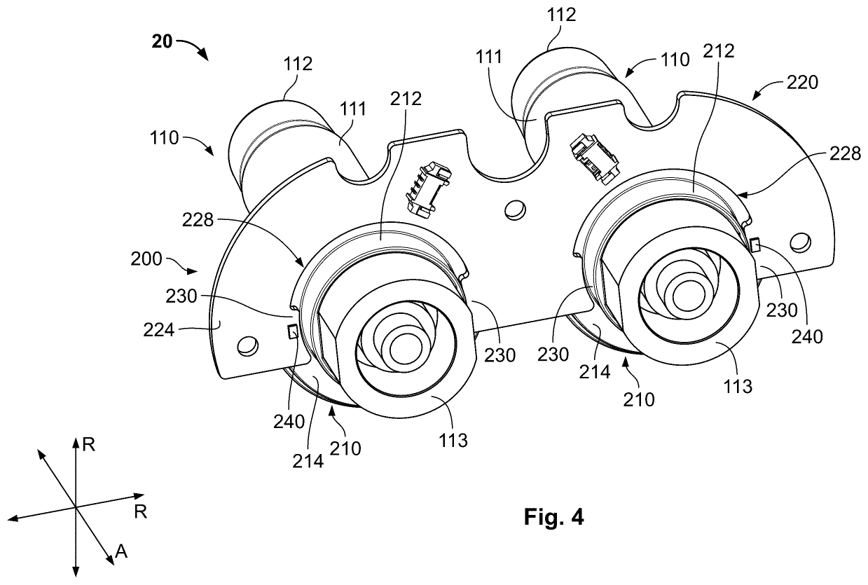

In the shown embodiment, as shown in detail in FIG. 4, the carrier 220 has a pair of contact receiving passageways 228 extending into the carrier 220. In various embodiments, the carrier 220 may have any number of contact receiving passageways 228 corresponding to the number of pins 110 of the connector 10. In another embodiment, the carrier 220 may have one contact receiving passageway 228 for one pin 110, and the connector 10 may include multiple carriers 220.

In the embodiment shown in FIG. 4, the carrier 220 has a pair of tabs 230 opposite one another and protruding into each of the contact receiving passageways 228 along the radial direction R. In another embodiment, the tabs 230 may be omitted and the carrier 220 may have a consistent dimension around each of the contact receiving passageways 228.

The carrier 220 may be formed of any type of insulative material used in PCBs, such as fiberglass, and has a plurality of traces used to connect electrical components mounted on the carrier 220 or otherwise connected to the carrier 220.

The temperature sensor 240, shown in FIGS. 4 and 5, has an outer face 242 and a mounted face 224 opposite the outer face 242 along the axial direction A. The mounted face 224 of the temperature sensor 240 is mounted on the carrier 220. The temperature sensor 240 may be a resistance temperature detector (RTD) sensor, a positive temperature coefficient (PTC) sensor, a negative temperature coefficient (NTC) sensor, or any other type of sensor that is capable of measuring a temperature of the pin 110 as described herein.

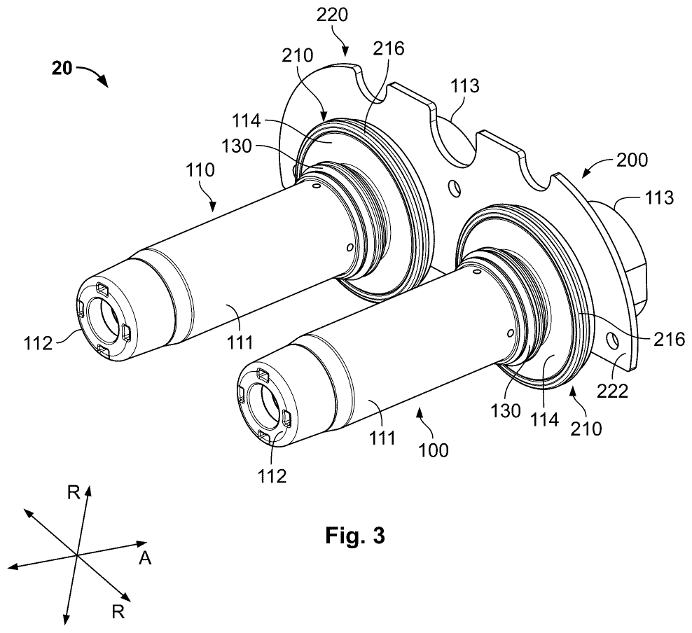

An assembly of the sensing system 20 will now be described primarily with reference to FIGS. 3 and 4. The sensor assembly 200 is positioned adjacent to the flange 114 of the at least one pin 110 in the sensing system 20.

As shown in FIGS. 3 and 4, one of the boots 210 is positioned around each of the pins 110. The boot 210 is slid onto the pin 110 from the connection end 113 until the boot 210 abuts and is positioned around the flange 114. In an assembled state of the boot 210 on the pin 110, as shown in FIGS. 3-5, the first section 212 of the boot 210 extends along the outer surface 120 of the body 111 of the pin 110 in the axial direction A, the second section 214 extends along the sensor side 116 of the flange 114 in the radial direction R, and the third section 216 extends over the outer side 118 of the flange 114 in the axial direction A. The boot 210 does not cover the housing side 117 of the pin 110 in the shown embodiment.

In the shown embodiment, each of the pins 110 having one of the boots 210 is positioned in one of the contact receiving passageways 228 of the carrier 220, as shown in FIGS. 3-5. The carrier 220 is positioned on a side of the flange 114 closer to the connection end 113 along the axial direction A. The carrier 220 abuts the second section 214 of each of the boots 210 and extends both at least partially around each of the pins 110 and between the pins 110. As shown in FIG. 4, the tabs 230 of the carrier 220 are positioned closer to the first section 212 of the boot 210 in the radial direction R than the rest of the carrier 220, overlapping more of the second section 214 and the flange 114 along the axial direction A than the rest of the carrier 220. As shown in FIG. 5, the carrier plane 226 along which the carrier 220 extends is parallel to the flange 114.

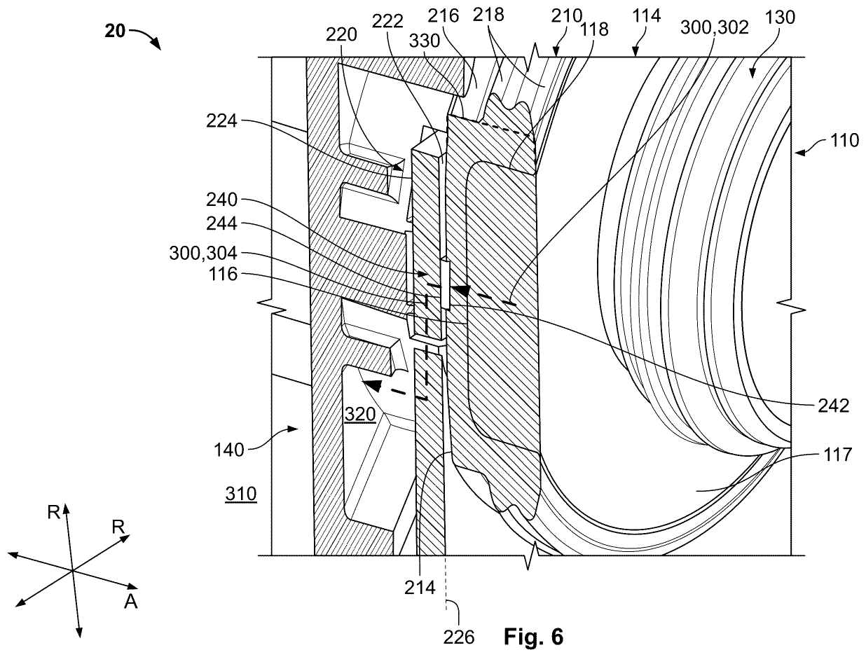

As shown in FIGS. 4 and 5, the mounted face 244 of the temperature sensor 240 is mounted on the carrier 220. In the embodiment shown in FIGS. 4 and 5, the first side 222 of the carrier 220 abuts the boot 210 and the temperature sensor 240 is mounted on the second side 224 of the carrier 220 facing away from the boot 210. In another embodiment of the sensor system 20, shown in FIG. 6, the temperature sensor 240 is mounted on the first side 222 of the carrier 220 facing the boot 210 along the axial direction A.

In both embodiments, shown in FIGS. 4-6, the outer face 242 of the temperature sensor 240 is parallel to the flange 114, and the temperature sensor 240 is mounted on the carrier 220 in a position in which the temperature sensor 240 is aligned with the flange 114 along the axial direction A. In the embodiment shown in FIGS. 4 and 5, the temperature sensor 240 is mounted on the tab 230 of the carrier 220. In other embodiments, the temperature sensor 240 may be mounted anywhere on the carrier 220 that is aligned with the flange 114 along the axial direction A, with the boot 210 positioned between the temperature sensor 240 and the outer surface 120 of the pin 110.

In an embodiment in which the sensing system 20 includes two pins 110, as shown in FIG. 4, the sensing system 20 includes two temperature sensors 240 mounted on the carrier 220. Each of the temperature sensors 240 is aligned with one of the pins 110 along the axial direction A. In another embodiment, the sensing system 20 can have more than one temperature sensor 240 aligned with each of the pins 110; in this embodiment, the second temperature sensor 240 associated with the pin 110 has the same position with respect to the pin 110 along the radial direction R and the axial direction A, but is displaced angularly from the first temperature sensor 240, for example by an angle greater than or equal to 90° and less than or equal to 180°.

The sensing system 20 including the at least one pin 110 and the sensor assembly 200 is positioned in the housing 100 as shown in FIGS. 2 and 5.

As shown in FIG. 2, each of the pins 110 is positioned in the housing 100 with the flange 114 at the connection side 104 of the housing and the mating end 112 of the pin 110 extending into the mating opening 106. The pins 110 are exposed in the mating opening 106 for mating with the mating connector. The boot 210 on each of the pins 110, at the boot ribs 218, is compressed between the flange 114 and the housing 100 to form a seal between the flange 114 and the housing 100.

The carrier 220 adjacent to the pins 110, as shown in FIGS. 2 and 5, is attached to the connection side 104 of the housing 100 by a plurality of first fasteners 250. The first fasteners 250 extend through the carrier 220 and into the housing 100 along the axial direction A. In the shown embodiment, the first fasteners 250 are bolts that engage with a threaded portion of the housing 100. In other embodiments, the first fasteners 250 can be any type of fastener, such as a screw, a clamp, or an adhesive, that is capable of securing the carrier 220 to the housing 100.

As shown in FIGS. 2 and 5, the connector 10 includes a seal 130 disposed on each of the pins 110. The seal 130 extends around an outer surface 120 of the pin 110, closer to the mating end 112 of the pin 110 than the flange 114, and has a plurality of seal ribs 132 protruding outward. The seal 130 is formed of an elastically deformable material and, in the assembled state shown in FIGS. 2 and 5, is compressed between the pin 110 and the housing 100 to form a seal between the pin 110 and the housing 100.

As shown in FIGS. 1, 2, and 5, the connector 10 includes a secondary lock 140 that is positioned around the pins 110 and the sensor assembly 200 and is connected to the housing 100. The secondary lock 140 is positioned on a side of the carrier 220 opposite the housing 100. The secondary lock 140 is formed of an insulative material, such as a plastic. The secondary lock 140 is connected to the connection side 104 of the housing 100 by a plurality of second fasteners 260. In the shown embodiment, the second fasteners 260 are bolts that engage with a threaded portion of the housing 100. In other embodiments, the second fasteners 260 can be any type of fastener, such as a screw, a clamp, or an adhesive, that is capable of securing the secondary lock 140 to the housing 100.

The secondary lock 140 has a pair of pin support structures 142 and a plurality of lock ribs 144. The pin support structures 142 each receive one of the pins 110 and, in an assembled position shown in FIGS. 2 and 5, abut the first section 212 of the boot 210 to secure the boot 210 in position. The lock ribs 144, in the assembled position, provide a force pressing the carrier 220 against the boot 210 and pressing the sensor assembly 200 against the flange 114 of the pin 110 along the axial direction A. The secondary lock 140 further secures the sensing system 20 to the housing 100.

The connector 10, as shown in FIGS. 1 and 2, includes a weld pad 150 attached to each of the pins 110 by a third fastener 270. The weld pads 150 are electrically connected to the pins 110 and provide for further transmission of the current received along the pins 110, for example within an electric vehicle. The weld pads 150 are a solid piece of conductive material and the third fasteners 270 connecting the weld pads 150 to the pins 110, such as bolts or screws, are formed of a conductive material to create an electrically conductive path away from the connection ends 113 of the pins 110.

An operation of the connector 10 having the sensing system 20 with the sensor assembly 200 will now be described in greater detail primarily with reference to the embodiments shown in FIGS. 5 and 6.

When a mating connector is mated with the connector 10, and mating pins of the mating connector mate with the pins 110 of the connector 10, an electrical current is transmitted through the pins 110. In the case of high currents or in other conditions, such as in electric vehicle applications, the current transmitted along the pins 110 increases the temperature of pins 110. The heating and detecting of the temperature of the pins 110 will be described hereinafter with reference to one of the temperature sensors 240 and one of the pins 110, but applies equally to each of the temperature sensors 240 associated with each of the pins 110 of the various embodiments of the connector 10.

As the temperature of the pin 110 increases, the pin 110 emits a heat in a flow path 300 shown in FIGS. 5 and 6. The flow path 300 includes a forward portion 302 between the outer surface 120 of the pin 110 and the temperature sensor 240 and a leak portion 304 between the temperature sensor 240 and an ambient air 310. To improve the accuracy of the detection of the temperature of the pin 110, a thermal resistance of the forward portion 302 of the flow path 300 should be minimized while a thermal resistance of the leak portion 304 of the flow path 300 should be maximized; optimizing transfer of heat to the temperature sensor 240 without rapidly losing heat to the ambient air 310.

In the forward portion 302 of the flow path 300, as shown in FIGS. 5 and 6, the heat travels from the flange 114 of the pin 110 along the axial direction A to the temperature sensor 240. The forward portion 302 of the flow path 300 extends only along the axial direction A and does not require changing direction to reach the temperature sensor 240, which decreases the thermal resistance of the forward portion 302. In the embodiment shown in FIG. 5, the forward portion 302 travels through the second section 214 of the boot 210 and through the carrier 220 to the temperature sensor 240. In the embodiment shown in FIG. 6, the forward portion 302 travels only through the second section 214 of the boot 210 to reach the temperature sensor 240, which further decreases the thermal resistance of the forward portion 302.

The leak portion 304 of the flow path 300, as shown in FIGS. 5 and 6, extends from the temperature sensor 240 through the carrier 220 to a confined space 320 adjacent to the pin 110. The confined space 320 is a still air that is confined by a portion of the connector 10; the confined space 320 is confined by the secondary lock 140 in the shown embodiments, but could be confined by other portions of the connector 10. The term “confined” as used in the present specification is intended to mean that the still air in the confined space 320 is at least partially contained and protected from ambient convection, but is not intended to mean that the still air is completely enclosed and sealed. The still air in the confined space 320 is in communication with the ambient air 310 but remains warmer than the ambient air 310 due to the protection from the convection in the ambient air 310 and the proximity of the confined space 320 to the heated pin 110. The confined space 320 filled with the warmer, still air, and the longer path to the ambient air 310, increases the thermal resistance of the leak portion 304 of the flow path 300.

In the embodiment of the sensing system 20 and the connector 10 described with respect to FIGS. 1-6 above, by placing the temperature sensor 240 on the carrier 220 adjacent to the flange 114 of the pin 110, the heat from the pin 110 is only required to travel in one direction and through minimal components along the forward portion 302 of the flow path 300 to the temperature sensor 240. The material of the carrier 220 is a poor thermal conductor and, by arranging the temperature sensor 240 such that the heat only travels a short distance through a minimal thickness of the carrier 220, the responsiveness and accuracy of the pin 110 temperature sensed by the temperature sensor 240 is improved. Creating the confined space 320 in the leak portion 304 prevents the heat that reaches the temperature sensor 240 from dissipating quickly, further improving the accuracy of the pin temperature sensed by the temperature sensor 240. The more accurate detection of the pin 110 temperature according to the sensor assembly 200 above allows for improved safety in applications in which heating of the pins 110 requires monitoring.

The sensing system 20 accomplishes the improved accuracy in pin 110 temperature detection while still maintaining a sufficient creepage path 330 between the pin 110 and the carrier 220, shown in FIGS. 5 and 6. The boot 210 having the third section 216 extending around the outer side 118 of the flange 114 lengthens the creepage path 330.

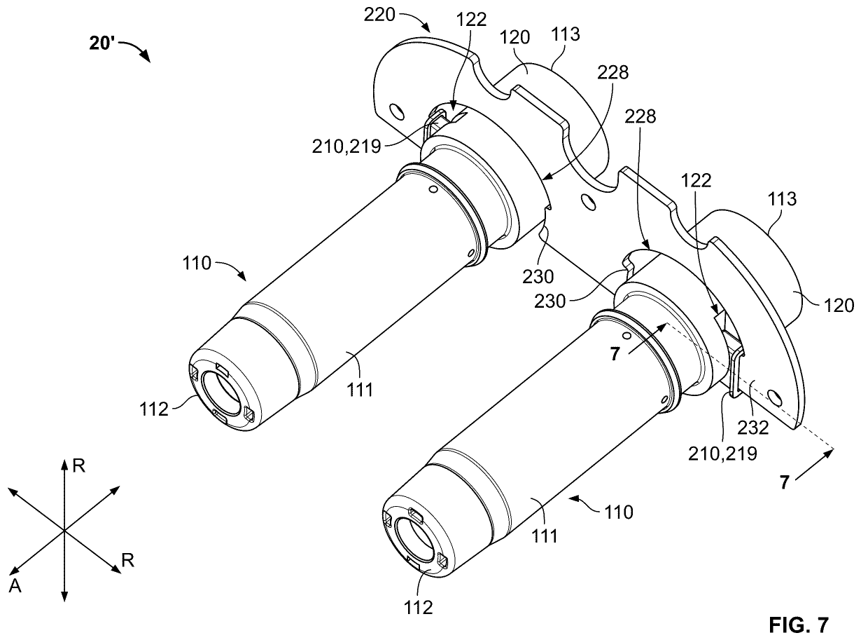

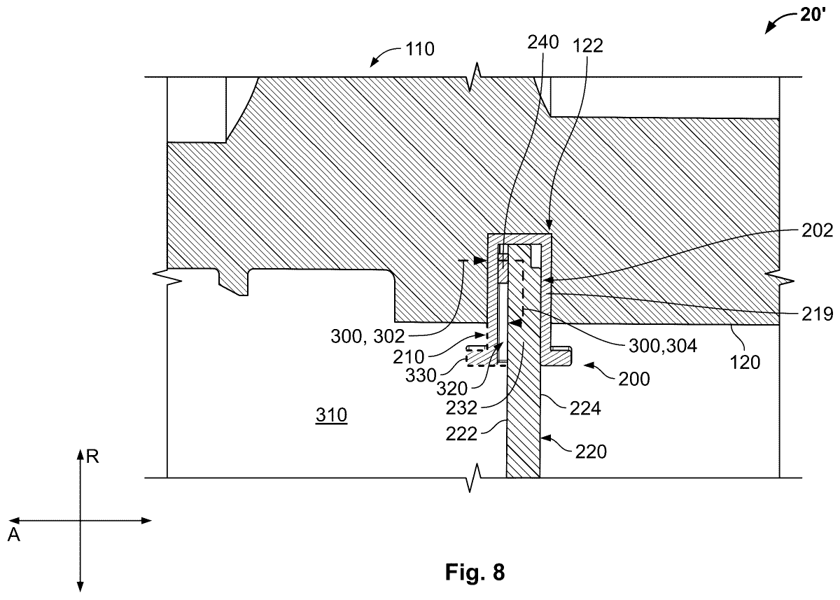

A sensing system 20′ according to another embodiment is shown in FIGS. 7 and 8. Like reference numbers refer to like elements in comparison with the sensing system 20 shown in FIGS. 1-6; primarily the differences of the sensing system 20′ will be described in detail below. The sensing system 20′ can be used in the connector 10 described above or with a housing 100 and a secondary lock 140 according to other embodiments.

The pin 110 of the sensing system 20′, as shown in FIG. 7, does not have a flange 114, but instead has a notch 122 extending into the outer surface 120 of the body 111 in the radial direction R. The notch 122, in the shown embodiment, is a slot extending into the outer surface 120 at only a portion of the circumference of the outer surface 120. The notch 122 is positioned closer to the connection end 113 than the mating end 112 along the axial direction A.

In the sensor assembly 200 of the sensing system 20′, as shown in FIGS. 7 and 8, the boot 210 does not have the sections 212, 214, 216, but is instead a sleeve 219 that surrounds a receiving space 202 on all sides except one side in the radial direction R. The boot 210 is formed of a same material as the boot 210 described with respect to the embodiment of FIGS. 1-6 above.

The carrier 220 of the sensing system 20′ is similarly shaped to the carrier 220 described with respect to the embodiment of FIGS. 1-6 above, but the carrier 220 of FIGS. 7 and 8 has a protrusion 232 in place of one of the tabs 230. The protrusion 232 is opposite one of the tabs 230 in each contact receiving passageway 228 and protrudes further into the contact receiving passageway 228 than the tab 230 in the radial direction R. The temperature sensor 240 is mounted on the protrusion 232.

As shown in FIGS. 7 and 8, the boot 210 formed as the sleeve 219 is positioned around the protrusion 232 and the temperature sensor 240 on the protrusion 232. The protrusion 232 is inserted into the notch 122 of the pin 110 with the boot 210 between the pin 110 and the temperature sensor 240. The temperature sensor 240 is positioned in the notch 122 and the carrier 220 and the boot 210 extend out of the notch 122.

While the pins 110 are used to conduct an electrical current and generate heat, the flow path 300 of the heat extends in the forward portion 302 along the axial direction A and directly to the temperature sensor 240 through the boot 210. The forward portion 302 extends only along the axial direction A and only through the material of the boot 210, which minimizes the thermal resistance of the forward portion 302. The leak portion 304 of the flow path 300 extends through the carrier 220 to the confined space 320 that is confined by the carrier 220 and the boot 210. The confined space 320 is adjacent to the pin 110, is heated by the pin 110, and communicates with but is confined from the ambient air 310, which maximizes the thermal resistance of the flow path 300. The sensing system 20′ thus also improves the responsiveness and accuracy of the pin 110 temperature sensed by the temperature sensor 240 while maintaining a sufficiently long creepage path 330 between the pin 110 and the carrier 220.

1. A sensing system, comprising:
a pin extending along an axial direction; and
a sensor assembly positioned adjacent to the pin, the sensor assembly includes a carrier, a temperature sensor disposed on the carrier, and a boot positioned between the temperature sensor and an outer surface of the pin, a flow path of a heat emitted by the pin extends along the axial direction from the outer surface of the pin to the temperature sensor.

2. The sensing system of claim 1, wherein the pin has a body extending along the axial direction and a flange perpendicular to the axial direction.

3. The sensing system of claim 2, wherein the temperature sensor is aligned with the flange along the axial direction.

4. The sensing system of claim 2, wherein the carrier extends along a carrier plane perpendicular to the axial direction, the carrier plane is parallel to the flange.

5. The sensing system of claim 2, wherein the temperature sensor has a mounted face disposed on the carrier and an outer face opposite the mounted face, the outer face is parallel to the flange.

6. The sensing system of claim 1, wherein the flow path includes a forward portion between the outer surface of the pin and the temperature sensor and a leak portion between the temperature sensor and an ambient air, the forward portion of the flow path extends only in the axial direction.

7. The sensing system of claim 6, wherein only the boot is between the outer surface of the pin and the temperature sensor along the axial direction in the forward portion of the flow path.

8. The sensing system of claim 6, wherein the temperature sensor is positioned on a side of the carrier opposite the boot, the boot and the carrier are between the outer surface of the pin and the temperature sensor along the axial direction in the forward portion of the flow path.

9. The sensing system of claim 6, wherein the leak portion extends from the temperature sensor through the carrier to a confined space adjacent to the pin.

10. The sensing system of claim 9, wherein the confined space communicates with the ambient air and contains a still air that is warmer than the ambient air.

11. The sensing system of claim 2, wherein the boot is formed of a thermally conductive and electrically insulative material.

12. The sensing system of claim 11, wherein the boot includes a first section extending along an outer surface of the body in the axial direction, a second section extending perpendicular to the axial direction along a temperature sensor side of the flange, and a third portion extending in the axial direction along an outer side of the flange.

13. The sensing system of claim 1, wherein the pin is one of a pair of pins and the temperature sensor is one of a pair of temperature sensors disposed on the carrier, the carrier extends between the pins and at least partially around each of the pins, each of the temperature sensors is aligned with one of the pins along the axial direction.

14. The sensing system of claim 1, wherein the pin has a notch extending into an outer surface of the pin perpendicular to the axial direction, the temperature sensor is positioned in the notch.

15. The sensing system of claim 14, wherein the carrier and the boot are positioned in the notch and extend out of the notch.

16. A connector, comprising:
a sensing system including a pin extending along an axial direction and a sensor assembly positioned adjacent to the pin, the sensor assembly includes a carrier, a temperature sensor disposed on the carrier, and a boot positioned between the temperature sensor and an outer surface of the pin, a flow path of a heat emitted by the pin extends along the axial direction from the outer surface of the pin to the temperature sensor.

17. The connector of claim 16, further comprising a housing having a mating opening, the pin is held in the mating opening and the carrier is attached to the housing.

18. The connector of claim 17, further comprising a secondary lock positioned on a side of the carrier opposite the housing, the secondary lock has a plurality of lock ribs pressing the carrier against the boot along the axial direction.

19. The connector of claim 18, wherein the flow path includes a forward portion between the outer surface of the pin and the temperature sensor and a leak portion between the temperature sensor and an ambient air, the forward portion of the flow path extends only in the axial direction.

20. The connector of claim 19, wherein the leak portion extends from the temperature sensor through the carrier to a confined space defined by the carrier and the secondary lock, the confined space communicates with the ambient air and contains a still air that is warmer than the ambient air.
